(19) United States
(12) Patent Application Publication
(10) Pub. No.: US 2010/0124190 A1
(43) Pub. Date: May 20, 2010

(54) METHOD FOR OPERATING A WIRELESS INTERCONNECTED DATA NETWORK WITH A PLURALITY OF NETWORK NODES, AND NETWORK NODES

(76) Inventor: Michael Bahr, Munich (DE)

Correspondence Address: Buchanan Ingersoll & Rooney PC (SEN), 301 Grant Street, 20th Floor, Pittsburgh, PA, 15219, US

(21) Appl. No.: 12/524,780

(22) PCT Filed: Aug. 28, 2007
(86) PCT No.: PCT/EP2007/058918

§ 371 Date: Dec. 30, 2009

(30) Foreign Application Priority Data
Jan. 29, 2007 (EP) 07001913.8

(51) Int. Cl. H04W 40/00

(52) U.S. Cl. 370/328

(57) ABSTRACT

A method is described for operating a wireless interconnected data network with a plurality of network nodes (MP1, MP2, MP 3, MP 4, MP S, MP D, NF MP) between which communications links (KV) exist, at least in part. At least some of the network nodes (MP1, MP2, MP 3, MP 4, MP S, MP D) forward received data packets to at least one of the network nodes (MP1, MP2, MP 3, MP 4, MP S, MP D, NF MP). At least one of the network nodes (NF MP) is designed as a prespecified network node. The prespecified network node (NF MP) suppresses the forwarding of data packets and the forwarding and/or the answering of data packets to the network nodes (MP1, MP2, MP 3, MP 4, MP S, MP D). Said data packets are transmitted in connection with the setting up of a data path in the data network and are not addressed to the prespecified network node (NF MP).

### CROSS REFERENCE TO RELATED APPLICATIONS

This application is the United States National Stage filing under 35 U.S.C. §371 of International Application No. PCT/EP2007/058918, filed on Aug. 28, 2007, and claiming priority to European Application No. 07001913.8, filed on Jan. 29, 2007. Both of the foregoing are incorporated by reference herein.

### BACKGROUND OF THE INVENTION

1. Field of the Invention

The invention relates to a method for the operation of a wireless, meshed data network with a plurality of network nodes, between at least some of which there are communication connections, with at least some of the network nodes forwarding received data frames to at least one network node, and with at least one of the network nodes being configured as a predetermined network node that does not forward data frames. The invention further relates to a network node for operation in a wireless, meshed data network with a plurality of network nodes, between at least some of which there are communication connections, with at least some of the network nodes forwarding received data frames to at least one network node.

2. Background of the Art

The transfer of data frames between one network node, referred to as the “source node,” and a network node referred to as the “destination node” can generally occur via various data highways, also referred to as “routes,” in wireless, meshed data networks. One route comprises a number of neighboring network nodes that are arranged in a row, have a data or communications connection to one another, and make a data connection between the source node and the destination node possible. So as not to leave the transfer of the data frames between the source node and the destination node up to chance, the source node sends out a “route request” (or “route request message”) to all neighboring network nodes (“broadcast”), which also forward the route request as part of a broadcast to the neighboring network nodes until the route request message finally reaches the destination node. The destination node initiates a “route reply” (or “route reply message”). In transmitting the route request message and the destination return of the route reply (“unicast”) to the source node, entries in “routing tables” are created on each network node. This provides a predefined path for the transfer of data frames between the source node and the destination node. “Route” refers to the data transmission highway of data frames via one or a plurality of network nodes, referred to as “intermediate nodes,” between the source node and the destination node.

The principle of wireless, meshed data networks is based on the fundamental forwarding of data frames through the network nodes of the data network. The current draft of the WLAN Mesh Networking Task Group IEEE 802.11s (D1.00) [1] further allows for “non-forwarding network nodes” (so-called non-forwarding mesh points). A non-forwarding network node is a network node that participates in the creation of the route, but does not forward data frames to other network nodes of the data network. This means that a non-forwarding network node can only be an endpoint, i.e., a source node or a destination node of a route of the wireless meshed data network.

Network nodes that do not support the forwarding of data frames received from other network nodes are generally not well tolerated in a wireless meshed data network because they do not behave cooperatively and reduce the connectivity of the data network.

Nonetheless, network node behavior in which data frames are not forwarded was accepted in IEEE Standard 802.11s, as a number of network nodes or potential network nodes are devices with a limited power supply, such as a personal digital assistant (PDA). The forwarding of data frames received from other network nodes can lead to high activity of the radio interface, which can have an adverse effect on the energy supply.

Routing protocols for wireless, meshed data networks generally assume that a network node will forward the data frames or data packets it receives. Mechanisms that take network nodes into account that, while part of the data network, do not forward data frames, are absent from many routing protocols. For example, this is also true of the IEEE 802.11s “Hybrid Wireless Mesh Protocol” (HWMP). However, this routing protocol describes a mechanism for actual stub nodes (or “WLAN terminals (STAs”)), which are outside of the mesh network and are connected with a network node that constitutes a mesh access point (MAP). This is described in Appendix P2.1 of [1]. The mesh access MAP that constitutes the network node before the stub node creates and processes routing messages on behalf of the stub node STA. Stub nodes STAs cannot forward data frames for other network nodes; they cannot process routing messages, and also cannot participate in the determination of the route.

### BRIEF SUMMARY OF THE INVENTION

Thus, the objective of the present invention is to make possible the integration of non-forwarding network nodes (mesh points) into existing routing protocols, such that such network nodes can, on the one hand, participate in the determination of the route, and, on the other hand, can also be a source node or destination node of data transfers. Furthermore, the objective of the present invention is to disclose a network node that can participate in a wireless meshed data network with several network nodes using existing routing protocols.

In the method disclosed by the invention for the operation of a wireless, meshed data network with a plurality of network nodes, between at least some of which there are communication connections, with at least some of the network nodes forwarding received data frames to at least one network node, and with at least one of the network nodes being configured as a predetermined network node that does not forward data frames, the predetermined network node suppresses the forwarding of data frames as well as the forwarding and/or response of data frames to network nodes that are transferred in connection with the creation of a route in the data network and are not addressed to the predetermined network node.

Thus, the method disclosed by the invention describes a way in which data frames, e.g., of the HWMP protocol, can be handled by the predetermined, i.e., non-forwarding, network nodes. Such a procedure has as yet not been included in the IEEE 802.11s D1.0 draft. The basic idea of the procedure is that routing messages, i.e., messages that are transmitted in the data network in connection with the creation of a route, which are normally answered, forwarded, or returned by the network nodes, are not forwarded, and can only be answered under certain conditions, by non-forwarding network nodes. In the IEEE protocol 802.11, these routing messages are also referred to as “management frames.” The concept of the data frame should generally be construed broadly in the present application. A data frame is intended, in the present description, to comprise those data frames that contain usage data and/or routing data. This means that the propagation of routing messages and of data broadcast messages stops at the predetermined, non-forwarding network nodes. The method disclosed by the invention requires no changes to existing routing protocols related to normal network nodes. All changes merely concern the at least one predetermined, i.e., non-forwarding, network node.

In accordance with one embodiment of the procedure, one or a plurality of the following messages, comprising at least one of the data frames, is processed by the predetermined network node:
A route request message, in which at least one of the network nodes is addressed as a destination node. Thus, the predetermined network node knows the route to the initiator or originator (=source node) of the route request message. Based on the above-described behavior of the predetermined network node, it does not become part of a route to the originator of the route request message, as it does not forward the route request message or does not answer it with a route reply message. For this reason, the predetermined network node does not have to forward any data frames for other network nodes. This means that the predetermined network node becomes a stub node of a “source tree.”
A route reply message addressed to the predetermined network node. Such a route reply message is processed normally as, e.g., in IEEE Standard 802.11s. Because the route reply message is addressed to the predetermined network node, it is not necessary for an updated route reply message to be broadcast.
A proactive route request message, with which all network nodes of the data network are addressed as destination nodes, in order to form a tree structure of the data network with the root network node as the root. The resultant entries in the routing tables show that the predetermined network node knows a route to the network node broadcasting the proactive route request message (“root network node”), but no network node creates a path to the network node broadcasting the proactive route request message including the predetermined network node, as the predetermined network node does not forward the proactive route request message. This means that the predetermined network node does not have to handle forwarding of data frames to the network node broadcasting the proactive route request message for other network nodes. Therefore, the predetermined network node becomes a stub node of the root tree. The predetermined network node creates, e.g., a proactive route reply message if a proactive route reply flag has been set.
A point-to-point route request message in which the predetermined network node is not addressed as the destination node. This is processed, e.g., in accordance with HWMP, but no updated point-to-point route request message is forwarded. Someone skilled in the art understands “point-to-point route request message” to mean a “unicast route request,” i.e., a route request message that is sent to exactly one network node.
A route request message in which the predetermined network node is addressed as the destination node. This is, by way of example, processed in accordance with HWMP and answered with a corresponding route reply message in accordance with HWMP.
A route reply message not intended for the predetermined network node. This case is relevant if the predetermined network node receives a route reply message not addressed to it, which will only occur in exceptional cases. In this case, the information contained in the message is nonetheless processed, e.g., in order to update the routing table of the predetermined network node. However, no updated route reply message is forwarded.
A route error message that signals an error of an existing route. This occurs in order to be able to take appropriate measures to repair the route with the error, which can, e.g., be initiated by the predetermined network node.

In accordance with a further embodiment of the invention, the predetermined network node addresses and transmits a route reply message to a network node that initiated the route request message if the predetermined network node is the addressee of the route request message, with the route request message and the route reply message respectively comprising at least one data frame. This means that, if the predetermined network node is the addressee of a route request message (i.e., the predetermined network node is the requested destination), the predetermined network node will respond as usual with a route reply message.

In accordance with a further embodiment, the predetermined network node suppresses addressing and transmission of a route reply message to a network node initiating a route request message, if the “destination only” flag is not set in the route request message and the predetermined network node knows a valid route to the network node designated as the destination in the route request message. The suppression of the route reply message in reaction to the route request message is contrary to a conventional network node in a data network.

The predetermined network node advantageously suppresses transmission of an updated proactive route request message to its neighboring network nodes. The predetermined network node knows, as discussed above, the route to the originator of the route request message. By not forwarding the proactive route request message, no route is created from one of the network nodes which includes the predetermined network node in the route determined. Thus, the non-forwarding or predetermined network node becomes a stub node of the tree structure.

In accordance with a further advantageous embodiment, after receiving a point-to-point route request message of one of the network nodes, in which the predetermined network node is not addressed as the destination node, the predetermined network node suppresses the transmission of an updated point-to-point route request message.

In accordance with a further advantageous embodiment, the predetermined network node suppresses the forwarding of a route reply message not addressed to it, i.e., an updated route reply message is not sent.

In accordance with a further embodiment, when it receives a route error message that, in particular, concerns a route request message initiated by it, the predetermined network node takes measures in order to rebuild the desired route. It can be provided that the predetermined network node suppresses forwarding of the route error message and/or answering of the route error message. This results from the fact that there is no need to answer or forward the route error message, as no route through the predetermined network node exists, as discussed above.

It is further provided that the predetermined network node processes a “root announcement” message (RANN) and suppresses forwarding to other network nodes. A root announcement message does not create a route. It only distributes distance information on the network node by which it was transmitted (“root network node”). The predetermined network node is merely a stub node of the tree, such that no network node will transmit data frames to the route network node through the predetermined network node. For this reason, the predetermined network node processes the RANN as set forth in the standard, but does not transmit any updated RANN. This procedure avoids reporting to other network nodes the distance from the root network node through the predetermined network node.

A further embodiment provides that the predetermined network node rejects data frames received by it that are not addressed to it. If the routing protocol HWMP works with the expansion for the predetermined network node, as described above, a predetermined network node will never receive a data frame that is not intended for it. Nonetheless, this may occur. The non-forwarding network node could then, e.g., have a valid route to the addressee of a received data frame. If the data frame were not rejected, this would lead to normal forwarding, which is not intended for the predetermined network node in accordance with the above definition. For this reason, a predetermined network node rejects all data frames that are not intended for it. It can be determined whether a data frame is intended for the predetermined network node, e.g., based on the destination address (Address 3), which, in this case, is the MAC address of the predetermined network node.

In accordance with a further embodiment, the predetermined network node processes the data frames that were transmitted by broadcast from one of the network nodes. In so doing, the predetermined network node suppresses forwarding of the data frames transmitted by broadcast from one of the network nodes. Data frames sent by broadcast are normally transmitted by broadcast by the receiving network node to its neighboring network node in accordance with the draft IEEE Standard 802.11s. A predetermined network node in accordance with the invention does process the data frames transmitted by broadcast, but does not forward them to its neighboring network nodes.

A further embodiment provides that the predetermined network node processes a “portal announcement” message (PANN) and suppresses forwarding of an updated PANN to other network nodes. A portal announcement message is not a message defined in HWMP. It is part of a separate protocol that announces the existence and availability of access to the network (“mesh portal”; this is a network node with the connection to an external network node, such as a gateway), and is basically similar to a RANN. Because network nodes cannot achieve network access via a predetermined network node because the forwarding of data frames is not provided for, a predetermined network node processes a PANN as usual, with updating and forwarding of the PANN, however being suppressed.

The invention further relates to a network node for operation in a wireless, meshed data network with several network nodes, between at least some of which there are communication connections, with at least some of the network nodes forwarding received data frames to at least one network node, and with at least some of the network nodes forwarding received data frames to at least one of the network nodes. The network node disclosed by the invention comprises means to suppress forwarding of data frames to the network nodes and to suppress the data frames with a routing message that are transmitted in connection with the creation of a route in the data network and are not addressed to the network node. The network node disclosed by the invention corresponds to the predetermined, non-forwarding network node of the above-described procedure disclosed by the invention and has the same advantages as described above. The network node disclosed by the invention can further include other means to carry out all modifications of the procedure described.

### BRIEF DESCRIPTION OF THE FIGURES

The invention is described below on the basis of the figures:

FIG. 1 a data network with several network nodes, of which one is configured as a non-forwarding network node,

FIG. 2 a logical diagram of the data network of FIG. 1,

FIG. 3 an exemplary embodiment, in which two routes are included within the data network according to FIG. 1,

FIG. 4 a logical diagram of the data network shown in FIG. 3 with the two routes,

FIG. 5 a further diagram of the data network, in which, compared to FIG. 3, an additional, third route is included, excluding the non-forwarding network node,

FIG. 6 a logical diagram of the data network shown in FIG. 5,

FIG. 7 routing tables for every network node of the data network in a state corresponding to FIG. 3, and

FIG. 8a) to f) routing tables of the network nodes of the data network and change to its content during the creation of the third route shown in FIG. 5.

### DETAILED DESCRIPTION OF THE INVENTION

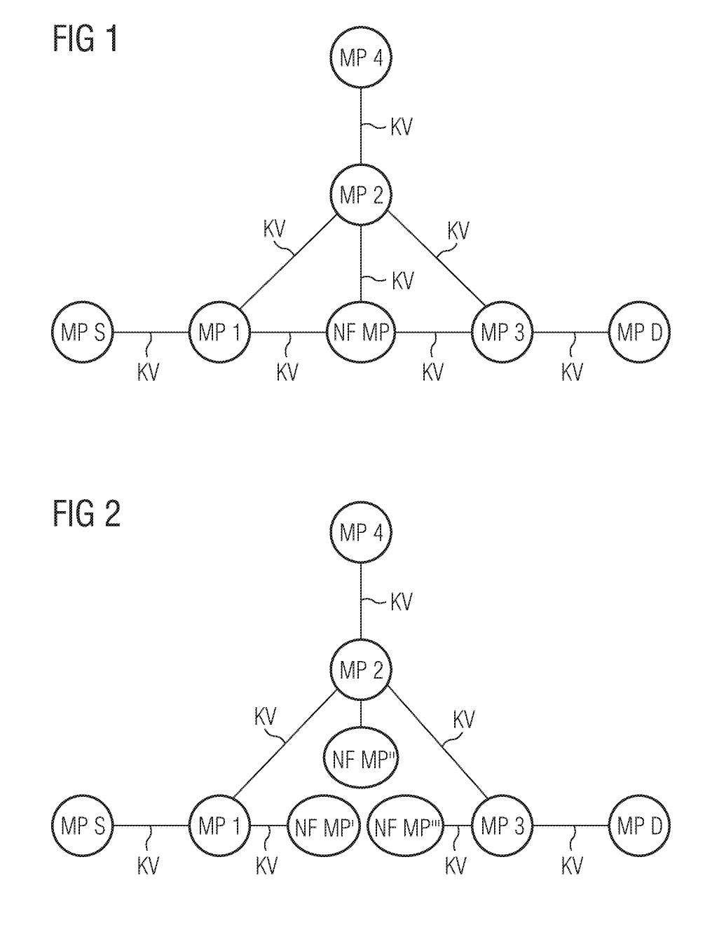

FIG. 1 shows an exemplary data network with a plurality of network nodes MP 1, MP 2, MP 3, MP 4, MP S, MP D, NF MP. Between two each of the network nodes MP 1, . . . , NF MP there is at least a partial communication connection KV. The communication connection KV is wireless. Thus, the data network shown in FIG. 1 is referred to as a “wireless meshed data network.” Every one of the network nodes has an address corresponding to the reference symbols MP S, MP 1, MP 2, MP 3, MP 4, MP D, NF MP and is used to differentiate between the network nodes.

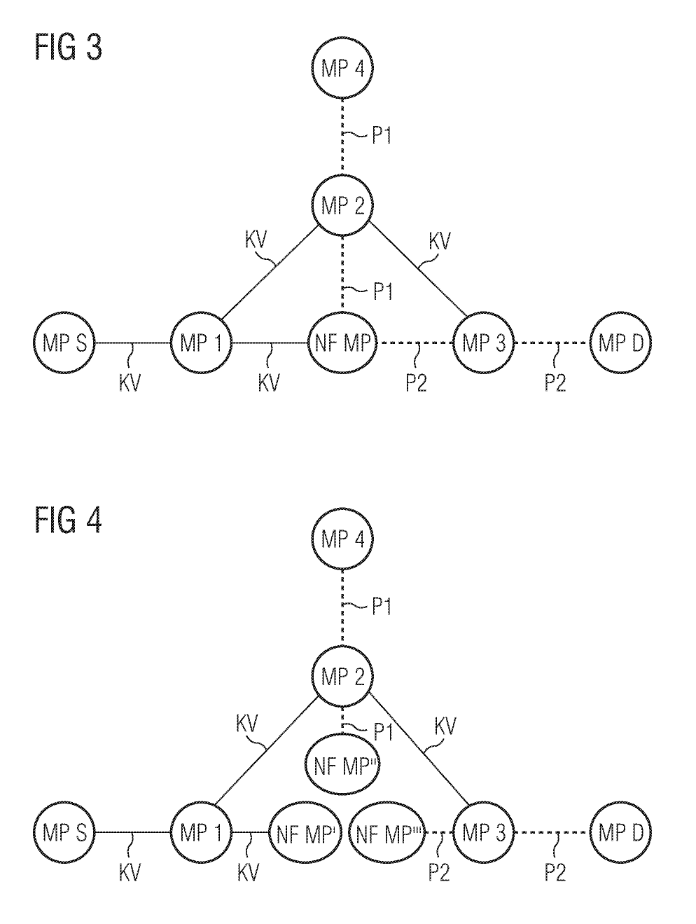

The network node NF MP is a “non-forwarding network node,” A non-forwarding network node is a network node that suppresses data frames received by neighboring network nodes and does not forward them to its neighboring network nodes. However, this does not mean that a non-forwarding network node, such as network node NF MP, is a stump node in a meshed data network. An actual stump node has only a single communication connection to a neighboring network node. As can be easily seen in FIG. 1, the non-forwarding network node NF MP, however, has communication connections to network nodes MP 1, MP 2, and MP 3. Non-forwarding network nodes thus are “multiple” stump nodes. This means that they can have a communication connection to more than one neighboring network node. However, there is no internal connection between these “stumps,” In contrast, a forwarding network node has this internal connection, which is necessary for the forwarding of data frames. A non-forwarding network node can therefore logically be seen as a plurality of actual stump nodes, as shown in FIG. 2. The non-forwarding network node NF MP of FIG. 1 is shown in FIG. 2 in the form of three network nodes NF MP′, NF MP″, and NF MP′″. Each of these real stump nodes NF MP′, NF MP″, and NF MP′″ has a single communication connection to network node MP 1, MP 2, or MP 3 respectively.

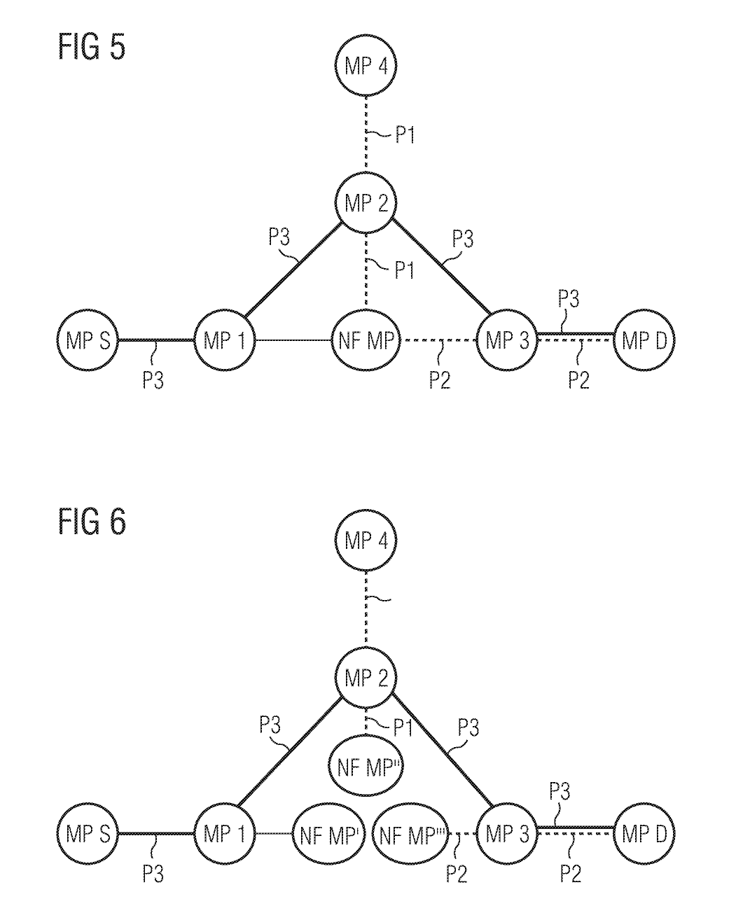

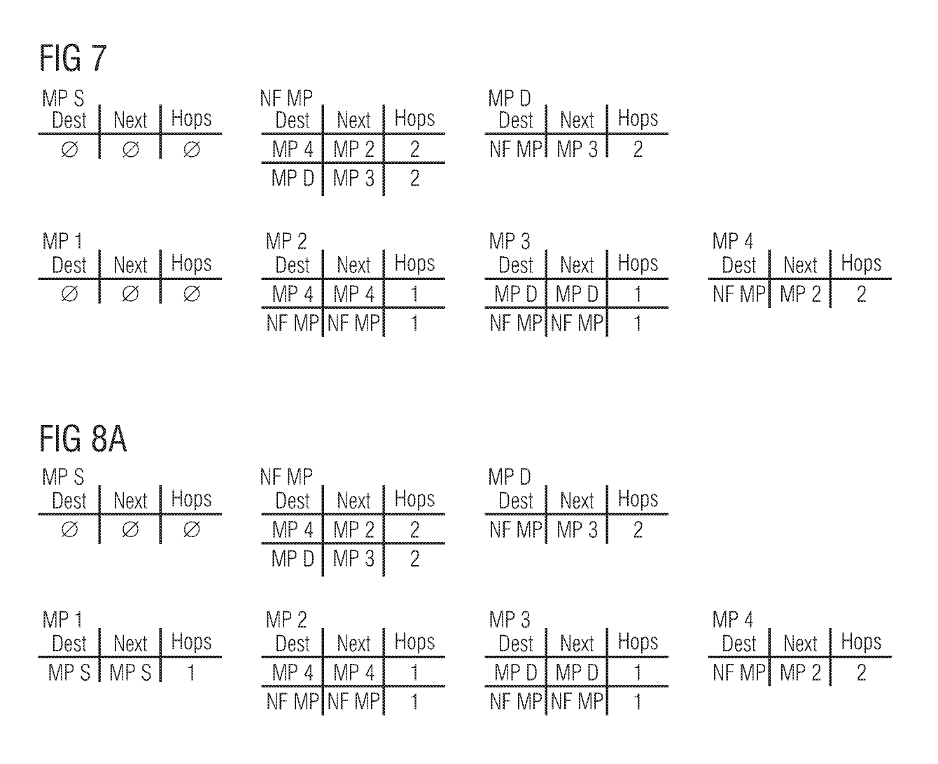

FIG. 3 shows a situation in which the network node NF MP has established a route P1 to network node MP 4 and a route P2 to network node MP D. The route P1 comprises network node MP 2 as an intermediate node. The route P2 comprises network node MP 3 as an intermediate node. While FIG. 3 shows the real communication connections in the data network, FIG. 4 shows the logical communication connections that concern primarily the non-forwarding network node NF MP. The diagram in FIG. 4 corresponds to the diagram in FIG. 2 described above.

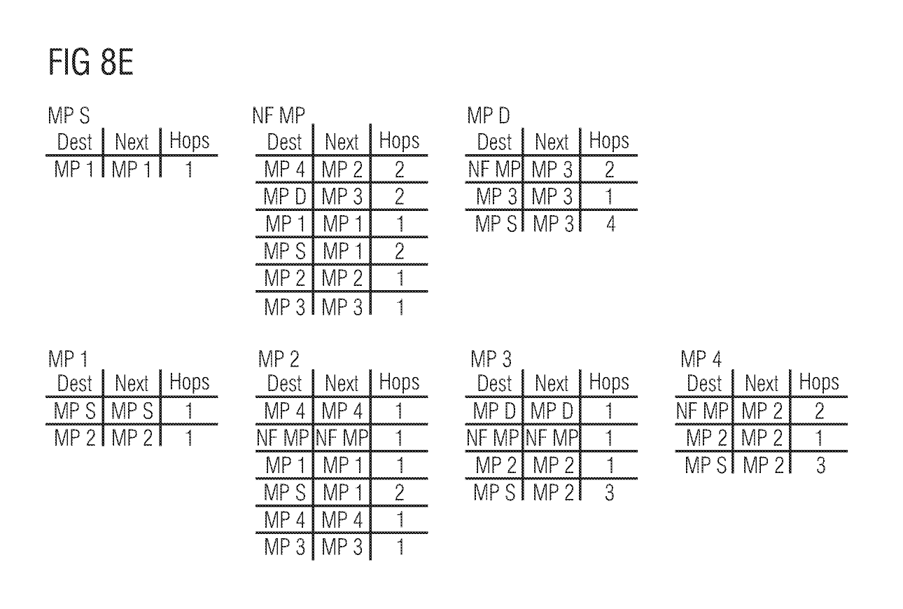

FIG. 7 shows the routing tables created after the creation of routes P1 and P2 for network nodes MP S, NF MP, MP D, MP 1, MP 2, MP 3, and MP 4 of the data network. The respective routing tables comprise three table entries: “dest” (destination) designates the destination, i.e., the destination node, of a message; “next” (next node) is the next network node in the route. “Hops” designates the number of hops, i.e., the number of network nodes to bridge to arrive at the destination node.

Because network nodes MP S and MP 1 are not located on either of routes P1 or P2, there are no entries for them in the relevant routing tables. The network node NF MP has two entries: the first line of the routing table concerns route P1 to network node MP 4 as destination. From the viewpoint of network node NF MP, the next network node is network node MP 2. Furthermore, two hops are needed in order to reach the destination node, network node MP 4. The second line concerns the second route P2 to arrive at destination node MP D. From the viewpoint of the non-forwarding network node NF MP, the next network node is network node MP 3. Two hops are needed, in turn, to reach destination node MP D.

The routing table for the network node MP D comprises one entry. This entry concerns the return route from network node MP D to non-forwarding network node NF MP as the destination node. From the viewpoint of MP D, the next network node to the destination node is network node MP 3, with two hops being needed in order to reach destination node NF MP.

The routing tables for network nodes MP 2, MP 3, and MP 4 are structured accordingly.

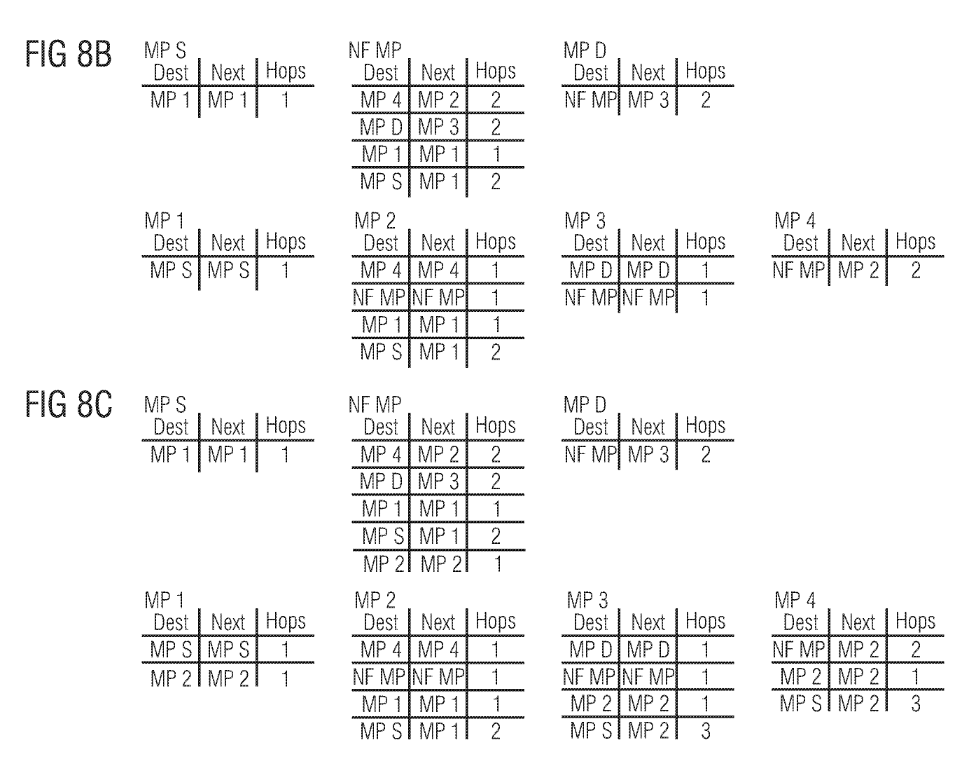

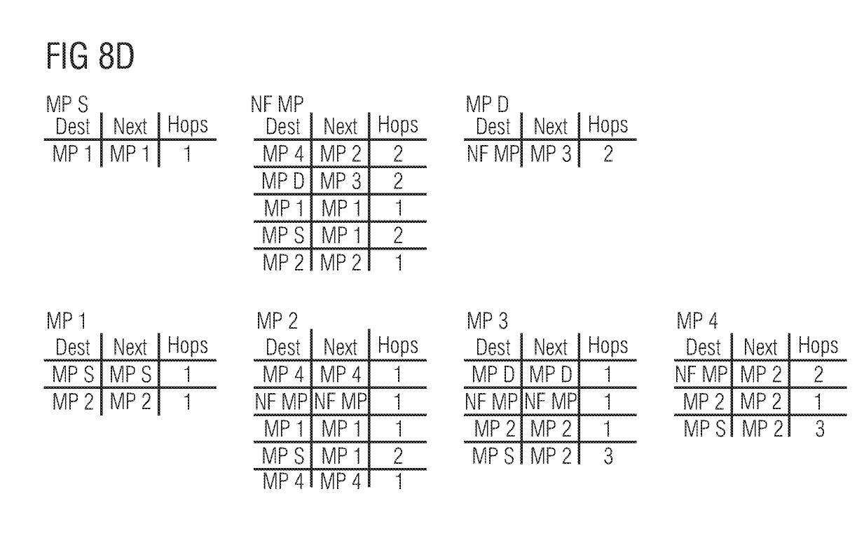

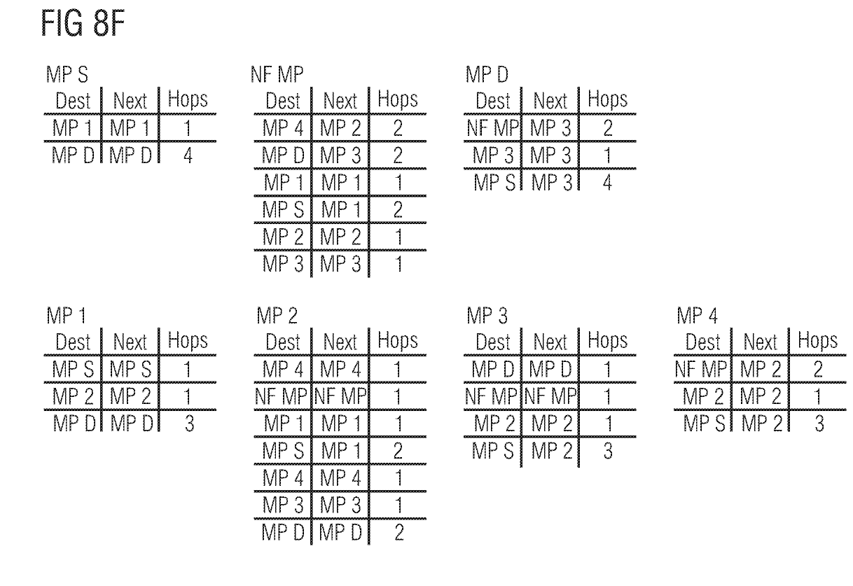

Referring to FIGS. 5 and 6, it is assumed below that network node MP S wishes to establish a route to network node MP D. To this end, MP S constitutes a source node and MP D a destination node of the route to be created. In examining the topology of the data network in accordance with FIG. 1 or FIG. 3, one could get the impression that the shortest route from MP S to MP D would lead through the non-forwarding network node NF MP. If the network node NF MP were included in the route, this would require forwarding of the data frames from MP S to MP D, and vice versa. Based on the assumption that NF MP is a non-forwarding network node, such as a communication terminal device, however, such forwarding is not provided for. Therefore, NF MP must be omitted from the route from MP S to MP D, such that forwarding of data frames through network node NF MP is not necessary. NF MP is omitted by having NF MP process the messages transmitted in connection with the creation of the route, but suppress responses to and/or forwarding of such messages or data frames. This procedure is discussed below in more detail based on FIG. 8, which shows the routing tables for the network nodes of the data network of the exemplary embodiment.

In a first step (FIG. 8a), the network node MP S transfers a route request message (“RREQ”) to destination node MP D. The route request message is sent by broadcast to all network nodes of the data network connected with MP S via a data connection (here: MP 1). Compared to the basic initial situation shown in the routing tables of FIG. 7, the route request message creates a table entry in the routing table of network node MP 1. Here, the table entry does not concern the forward route in the direction of destination node

MP D, but rather the return route to source node MP S, as this is initially the only information that network node MP 1 can acquire from the route request message. For this reason, the destination is entered as network node MP S, the next network node is entered as network node MP S, with the distance between network node MP 1 and destination node MP S being one hop.

In a second step (FIG. 8b), an updated route request message is transmitted by network node MP 1 as a response or reaction to the route request message of source node MP S, which is received by all network nodes connected with MP 1 (MP S, MP 2, NF MP). The non-forwarding network node NF MP suppresses the transmission of an updated version of this route request message and leaves it unanswered. Furthermore, the non-forwarding network node does not answer with a route reply message (“RREP”) in a possible function as intermediate node between source node MP S and destination node MP D. The same applies even if the “destination only flag” is not set in the route request message, although network node NF MP already knows a valid route to network node MP D. The transmission of the updated route request message by network node MP 1 causes an update to the routing tables of network nodes MP S, NF MP, and MP 2. In the routing table of network node NF MP, two table entries for the destination of network nodes MP 1 and MP S are entered. Correspondingly, in the routing table of network node MP 2, two entries are made for network nodes MP 1 and MP S as destinations. Furthermore, in the routing table of MP S, an entry for MP 1 as the destination node is made.

In a third step (FIG. 8c), an updated route request message is transmitted by network node MP 2, in which network node MP D is listed as the destination. This updated route request message is received by network nodes NF MP, MP 3, and MP 4, as well as MP 1. The non-forwarding network node NF MP suppresses such transmission of an updated version of this route request message. Nor does NF MP respond with a route reply message in its function as potential intermediate node. This applies even if the “destination only flag” is not set, although NF MP already knows a valid route to destination node MP D.

The updated route request message transmitted by network node MP 2 is received by network nodes MP 1, MP 3, MP 4, and non-forwarding network node NF MP. Table entries are made correspondingly in the routing tables of these network nodes. Network node NF MP acquires information related to a route to network node MP 2. Network node MP 1 also acquires information about a route to network node MP 2. In addition to information on network node MP 2, network node MP 3 also acquires information about a route to source node MP S. The same applies to network node MP 4.

In a fourth step (FIG. 8d), an updated route request message is transmitted by network node MP 4, with network node MP D being listed as the destination. This merely causes a change in the routing table of network node MP 2, as this is the only one that receives the updated route request message from MP 4.

In a further step (FIG. 8e), an updated route request message is transmitted by network node MP 3, in which MP D, in turn, is listed as the destination. This is received by network node MP 2, destination node MP D, as well as the non-forwarding network node NF MP. In accordance with the procedure described above, NF MP does not send an updated version of this route request message. Nor does NF MP answer with a route reply message in its function as intermediate network node. This applies even if a “destination only flag” is not set, although NF MP knows a valid route to MP D.

The network nodes MP 2, MP D, and NF MP, which receive the updated route request message, react by updating their routing tables, with the process proceeding in accordance with the description above.

Step 4 and step 5 of the procedure described can also proceed in the opposite order.

In a final step (FIG. 8f), MP D transmits a route reply message (“RREP”) to source node MP S, which initiated the route request message, via the return route established, MP D-MP 3-MP 2-MP 1-MP S. This route is marked in FIGS. 5 and 6 with P3 and a thick continuous line. FIG. 5 shows the data network with the real communication connections, while FIG. 6 shows the logical communication connections of the non-forwarding network node NF MP. In the final step, the routing tables of network nodes MP S, MP 1, MP 2, and MP 3 are updated. This occurs in accordance with the process described above.

Thus, the establishment of the route between source node MP S and destination node MP D is completed; with the non-forwarding network node NF MP not being included in route P3 due to its behavior. Under normal circumstances, network node MP 2 will forward data frames intended for network node MP D to network node MP 3. If MP 2, for any reason, should instead forward a data frame to NF MP, NF MP could forward it to destination node MP D, as it knows a valid route to MP D. However, this is not provided for by the invention. NF MP generally does not forward such data frames; it rejects them.

[1] IEEE P802.11s™/D1.00, Draft Amendment to Standard for Information Technology—Telecommunications and Information Exchange Between Systems—LAN/MAN Specific Requirements—Part 11: Wireless Medium Access Control (MAC) and physical layer (PHY) specifications: Amendment: ESS Mesh Networking. IEEE 802.11 Working Group, November 2006, work in progress.

1. A method for the operation of a wireless meshed data network with a plurality of network nodes, between at least some of which there are communication connections, with at least some of the network nodes (forwarding received data frames to at least one network node, and with at least one of the network nodes being configured as a predetermined network node that does not forward data frames, characterized in that the predetermined network node suppresses the forwarding of the data frames as well as the forwarding and/or response of the data frames to the network nodes, which are transmitted in connection with the creation of a route in the data network and are not addressed to the predetermined network node.

2. The method of claim 1, wherein one or a plurality of the following messages, comprising at least one of the data frames, is processed by the predetermined network node:
a route request message in which one of the network nodes is addressed as a destination node;
a route reply message addressed to the predetermined network node;
a proactive route request message with which all network nodes of the data network are addressed as destination nodes in order to form a tree structure of the data network;
a point-to-point route request message in which the predetermined network node is not addressed as the destination node;
a route request message in which the predetermined network node is addressed as the destination node;
a route reply message not intended for the predetermined network node; and
a route error message with which an error of an existing route is signaled.

3. The method of claim 1, wherein the predetermined network node addresses and transmits a route reply message to one network node that has initiated a route request message, if the predetermined network node is the addressee of the route request message, with the route request message and route reply message each comprising one data frame.

4. The method of claim 1, wherein the predetermined network node suppresses addressing and transmission of a route reply message to a network node that has initiated a route request message, if a “destination only” flag has not been set in the route request message and the predetermined network node knows a valid route to the network node designated as the destination in the route request message.

5. The method of claim 2, wherein the predetermined network node suppresses a transmission of an updated proactive route request message to its neighboring network node.

6. The method of claim 2, wherein the predetermined network node suppresses the transmission of an updated point-to-point route request message after receiving a point-to-point route request message of one of the network nodes in which the predetermined network node is not addressed as the destination node.

7. The method of claim 2, wherein the predetermined network node suppresses the forwarding of a route request not addressed to it.

8. The method of claim 2, wherein the predetermined network node, when it receives a route error message concerning a route request message initiated by it, reestablishes the desired route.

9. The method of claim 8, in which the predetermined network node suppresses at least one member of the group consisting of forwarding of the route error message and a response to the route error message.

10. The method of claim 2, wherein the predetermined network node processes a root announcement message and suppresses forwarding to other network nodes.

11. The method of claim 2, wherein the predetermined network node rejects data frames it receives that are not addressed to it.

12. The method of claim 1, wherein the predetermined network node processes the data frames transmitted by broadcast by one of the other network nodes.

13. Method in accordance with claim 12, in which the predetermined network node suppresses forwarding of the data frames transmitted by broadcast by one of the other network nodes.

14. The method of claim 1, wherein the predetermined network node processes a portal announcement message and suppresses forwarding to other network nodes.

15. A network node for operation in a wireless meshed data network with a plurality of network nodes, between at least some of which there are communication connections (KV), with at least some of the network nodes forwarding received data frames to at least one of the network nodes, said network node comprising means to suppress the forwarding of the data frames to the network nodes and to suppress at least one of forwarding and responding to the data frames with a routing message, which are transmitted in the data network in connection with the creation of a route and are not addressed to the network node.

16. A network node in accordance with claim 15, further comprising means to carry out the procedure disclosed by claim 2.
